(19) United States
(12) Patent Application Publication
(10) Pub. No.: US 2013/0252041 A1
(43) Pub. Date: Sep. 26, 2013

(54) Electrode for High Performance Metal Halogen Flow Battery

(71) Applicant: PRIMUS POWER CORPORATION, Hayward, CA (US)

(72) Inventors: Mai Fujimoto, Hayward, CA (US); Brad Kell, Pembroke, MA (US); Gerardo Jose la O', Alameda, CA (US); Jonathan Hall, San Mateo, CA (US); Lauren Wessel Hart, San Francisco, CA (US); Pallavi Pharkya, Fremont, CA (US); Paul Kreiner, San Francisco, CA (US); Kyle Haynes, Redwood City, CA (US); Andrew Marshall, San Mateo, CA (US); Russell Cole, San Francisco, CA (US); Leon Radomsky, Vienna, VA (US)

(73) Assignee: Primus Power Corporation, Hayward, CA (US)

(21) Appl. No.: 13/850,729

(22) Filed: Mar. 26, 2013

Related U.S. Application Data
(60) Provisional application No. 61/615,544, filed on Mar. 26, 2012.

(51) Int. Cl. H01M 10/36; H01M 2/40; H01M 10/38

(52) U.S. Cl. CPC H01M 10/36; H01M 10/38; H01M 2/40
USPC 429/70; 427/58; 427/126.5; 429/209; 429/231.5

(57) ABSTRACT

A porous electrode for a flow battery includes a first layer and a second layer. The first layer has at least one of a different catalytic property or a different permeability than the second layer.

### CROSS-REFERENCE TO RELATED PATENT APPLICATION

The present application claims benefit of priority of U.S. Provisional Patent Application No. 61/615,544, filed on Mar. 26, 2012 which is incorporated herein by reference in its entirety.

This invention was made with Government support under contract DE-AR0000143 awarded by Department of Energy. The Government has certain rights in the invention.

### FIELD

The present invention is generally directed to flow batteries and more specifically to electrodes for flow batteries.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such an energy storage is a so-called “flow battery” which uses a halogen component for reduction at a normally positive electrode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen.

Such electrochemical energy systems are described in, for example, U.S. Pat. Nos. 3,713,888, 3,993,502, 4,001,036, 4,072,540, 4,146,680, and 4,414,292, and in EPRI Report EM-I051 (Parts 1-3) dated April 1979, published by the Electric Power Research Institute, the disclosures of which are hereby incorporated by reference in their entirety.

### SUMMARY

An embodiment relates to a porous electrode for a flow battery which includes a first layer and a second layer, wherein the first layer has at least one of a different catalytic property or a different permeability than the second layer.

Another embodiment relates to a method of making a porous electrode for a flow battery, comprising providing a first substrate layer comprising a sintered metal or metal oxide powder substrate layer, and coating a portion of the first substrate layer with a mixed metal oxide catalytic coating.

### BRIEF DESCRIPTION OF THE DRAWINGS

FIGS. 1A, 1B, 1C, 1D and 2 are schematic side cross sectional view illustrations of multi-porous electrodes according to various embodiments.

FIG. 3A is a perspective view of a multi-porous electrode with junction ribs and a sealing rim according to an embodiment. FIG. 3B is a close up of the multi-porous electrode of FIG. 3A. FIG. 3C is a close up of FIG. 3B. FIG. 3D is a micrograph illustrating the microstructure of a cross section of the multi-porous electrode of FIG. 3A.

FIGS. 4A, 4B, 4C and 4D are alternative schematic side cross sectional view illustrations of a cell with a restriction layer according to various embodiments.

FIG. 4E is a top view of a cell frame.

FIG. 4F is a schematic side cross sectional view of a flow battery system of the embodiments of the invention.

FIG. 5 is a schematic side cross sectional view illustration of six electrode configurations used in a computational fluid dynamics simulation.

FIG. 6 is a plot illustrating results comparing electrolyte velocity in electrodes with and without an additional restriction layer.

FIG. 7 is a plot illustrating results comparing electrolyte velocity in electrodes having baffle configurations with a configuration lacking a gap.

FIG. 8 is a plot illustrating average pore size of multi-layer electrodes according to embodiments.

FIG. 9 is a plot illustrating surface area of multi-layer electrodes according to embodiments.

FIG. 10A is a micrograph illustrating the microstructure of porous electrodes with a mesh-325 monolayer. FIG. 10B is a micrograph illustrating the microstructure of porous electrodes with a mesh-325 and mesh-100 bilayer.

FIG. 11 is a simulation showing flow velocity with and without restriction layer through an electrode according to an embodiment.

FIG. 12A is a plot showing the effect of a restriction layer on flow velocity. FIG. 12B is a plot showing the effect of a restriction layer and a gap on flow velocity.

FIG. 13 is a plot illustrating electrochemical polarization curves at different charge and discharge current densities obtained with the porous electrodes made from different mesh sizes material.

### DETAILED DESCRIPTION

Embodiments include a multilayer positive electrode structure for a metal halogen flow cell. The multilayer electrode structure provides one or more of the following advantages over conventional positive electrodes: a more uniform fluid flow and pressure distribution, high electrochemical reaction kinetics, high mechanical integrity, excellent manufacturing tolerance as well as lower cost.

In some embodiments, the porous electrode includes a first layer and a second layer, where the first layer has a different catalytic property and permeability than the second layer. Specifically, in some embodiments, the first layer (e.g., layer 106, 106A or 107 described below) has a lower catalytic property and a higher flow resistance than the second layer (e.g., layer 108 and/or 109 described below). The first layer may comprise at least one of a porous metal or metal oxide foam layer 106A, or a porous sintered metal or metal oxide powder layer 106 or 107. The second layer may comprise at least one of sintered metal oxide powder layer 108 which catalyzes oxidation of a metal-halide electrolyte to form halogen ions, or a sintered metal or metal oxide powder layer 107 portion which is coated with a mixed metal oxide catalytic coating 109 which catalyzes oxidation of the metal-halide electrolyte to form the halogen ions. The first layer is preferably thicker than the second layer.

An embodiment is drawn to an electrode that is permeable to the electrolyte and fabricated by sintering metal oxide powder and/or by sintering a metal powder and then coating it with a metal oxide (i.e., catalytic) coating. The metal oxide powder can be, but is not limited to, titanium oxide, tantalum oxide, tungsten oxide and oxides of other refractory metals, the metal powder can be, but is not limited to, titanium, tantalum, tungsten, or other refractory metals and their alloys, and the metal oxide coating (e.g., catalytic coating) may be a mixed metal oxide comprising a mixed refractory and noble metal oxide, such as a mixed titanium oxide and ruthenium oxide (i.e., ruthenized titania), or mixtures of other refractory and noble metal oxides. The catalytic coating catalyzes conversion of a metal halide electrolyte (e.g., a zinc-bromine or zinc-chloride aqueous electrolyte) to metal and halogen ions (e.g., zinc ions and bromine or chlorine ions). In other words, the catalytic coating catalyzes oxidation of the metal-halide electrolyte to form the halogen ions.

In a first embodiment, the positive electrode is produced by sintering metal powders or metal oxide powders such as titanium, tantalum, tungsten, titanium oxide, tantalum oxide, tungsten oxide or combinations thereof. The sintered powder becomes a porous structure with high surface area, uniform thickness and desired pore size and permeability. In one embodiment, the porous structure acts as a positive electrode substrate which is at least partially coated with a mixed metal oxide catalytic coating to complete the positive electrode. In another embodiment, the mixed metal oxide catalytic coating is omitted when at least a part of the porous structure comprises a sintered metal oxide powder which itself acts as the catalyst.

Typically, finer and/or tighter distributed particles are more expensive to make than coarser and/or looser distributed particles. As used herein, particle distribution refers to the half maximum width of a peak in a plot of particle size (e.g., diameter) versus number of particles of that size in the powder. A tighter distribution has a smaller half maximum peak width in this plot than a looser distribution.

Thus, to save cost, electrodes made by powder metallurgy are typically fabricated with coarser and/or looser distributed particles. However, fabrication with smaller and/or tighter distributed particles yields an electrode with increased surface area which produces superior electrochemical performance in the battery. By fabricating a multi-layer electrode having a layer made of coarser and/or looser distributed particles and a layer of finer and/or tighter distributed particles, an electrode with the superior electrochemical performance of the finer particles can be achieved at less cost than an electrode made entirely from finer and/or tighter distributed particles.

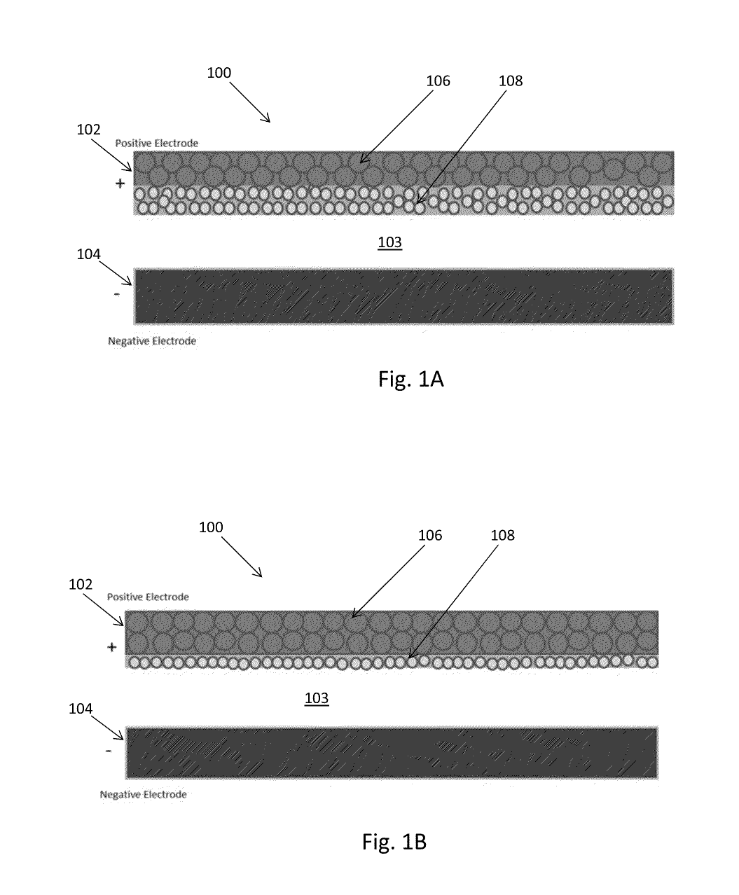

FIGS. 1A-1D and 2 illustrate embodiments of an electrochemical cell 100, such as a flow cell of a flow battery, having a multi-porous positive electrode 102 and a non-porous (i.e., fluid impermeable) negative electrode 104 separated by a reaction zone 103. Preferably, the battery comprises a hybrid flow battery having a single flow loop and no separator in the reaction zone 103 between the electrodes 102, 104. In the hybrid metal halide flow battery, at least a part of the electrolyte flows through the porous positive electrode 102 and the metal (e.g., zinc) is plated in charge mode onto the surface of the negative electrode 104 facing the reaction zone 103.

In the embodiment illustrated in FIG. 1A, the multi-porous electrode 102 is a bi-layer electrode. The bilayer multi-porous electrode 102 includes two layers 106, 108 that are made from powders of different mesh size and/or different distribution. For example, a powder that is designated as “325 mesh” passed though a 325 mesh screen and the powder's particle size (i.e., the maximum particle diameter) is less than 44 microns. That is, the bilayer multi-porous electrode 102 includes a first, coarse and/or looser distributed sintered powder layer 106 that is made from coarser (e.g., larger mesh size) and/or looser distributed particles, and a second, finer and/or tighter distributed sintered powder 108 made from finer particles (e.g., with a smaller mesh size) and/or tighter distributed particles than that of the layer 106.

Preferably, when using the bilayer multi-porous electrode 102 in a flow battery, the finer and/or tighter distributed particle side 108 of the (positive) electrode 102 is placed facing the reaction zone 103 and the negative electrode 104 of the electrochemical cell 100 to take advantage of the higher surface area and/or an increased functional surface area of the layer 108 during the electrochemical reaction in the flow battery. An increased functional surface area has a more uniform roughness and/or pore size as a function of area of the electrode 102 facing the reaction zone due to the tighter sintered particle distribution of layer 108 in the electrode 102. In contrast, layer 106 provides a less expensive, electrically conductive structural backbone for the electrode 102.

The electrode 102 may be made by separately sintering powders to form layers 106, 108 and then joining the layers 106, 108 to form the electrode. Alternatively, green layers 106, 108 or packed powder layer 106, 108 may be placed in contact with each other followed by a single common sintering step to form electrode 102. Alternatively, one layer (e.g., layer 106) is formed and sintered first, followed by forming the other green layer (e.g., layer 106) on the sintered layer (e.g., 108), followed by a second sintering step. If desired, the mixed metal oxide catalytic coating may be applied to layer 108, especially if the layer 108 is made from metal rather than metal oxide sintered particles.

FIG. 1B illustrates an alternative embodiment of the multi-porous electrode 102. In this embodiment, the layer 108 includes a layer of metal powder that is sprayed on one side (e.g., the reaction zone 103 facing side) of the layer 106. Any spraying, such as plasma-arc spray, shrouded plasma-arc spray, high velocity, oxy-fuel (HVOF), electric arc-spray, flame spray, or cold spray, may be used. Layer 108 may be sprayed onto a sintered layer 106 followed by a second sintering step or layer 108 may be sprayed onto layer 106 which comprises a green precursor or packed powder followed by a single common sintering step. Layer 108 may be formed by spraying either a sintered or unsintered powder or a green precursor onto layer 106. A post spraying sintering step is optional. The mixed metal oxide catalytic coating may then be applied to layer 108.

The layer 108 may include, but is not limited to, particles, of finer and/or tighter distributed titanium powder. The layer 106 may also include, but is not limited to sintered titanium powder having a coarser and/or looser distributed powder particles. As with the first embodiment, the layer 108 of the electrode 102 is preferably placed facing the negative electrode 104 in a flow battery cell to take advantage of the higher and/or improved functional surface area during the electrochemical reaction in the flow battery. In this embodiment, the mixed metal oxide coated sintered powder titanium layer 108 provides a region for high electrochemical activity, while layer 106 provides structural integrity at a lower cost.

FIG. 1C illustrates an alternative embodiment in which the position of layers 106 and 108 is reversed with respect to FIGS. 1A and 1B, such that layer 106 faces the reaction zone 103 and the negative electrode 104 of the same cell while layer 108 faces away from the reaction zone 103. The particle size of the layer 106 facing the negative electrode 104 is optimized to facilitate the application of a catalytic coating (e.g. the mixed metal oxide coating), while the particle size of the layer 108 facing away from the negative electrode 104 is optimized to achieve desirable flow control properties, such as permeability. Thus, the coarser sintered powder layer 106 faces the negative electrode 104 and the finer sintered powder layer faces away from the negative electrode 104. The catalytic coating is applied to the surface of layer 106 facing the reaction zone 103 and the negative electrode 104.

FIG. 1D illustrates an alternative embodiment in which the positive porous electrode 102 comprises a single porous substrate layer 107, such as a sintered refractory metal powder layer (e.g., sintered titanium powder layer) designed to achieve the desired conductivity, stiffness, and surface area. To achieve the desired electrochemical activity, the catalytic coating 109 is applied to the surface 107A of this substrate layer 107 facing the reaction zone 103 and the negative electrode 104. However, since the catalytic coating 109 material is expensive, it is applied so that it does not penetrate and coat the entire substrate layer 107 thickness, but rather only penetrates to a predetermined depth 107B from surface 107A achieve the desired catalytic activity.

For example, the substrate layer 107 may comprise a sintered refractory metal (e.g., titanium) powder layer having a relatively loose distribution of powder particles. Layer 107 is then coated from the side facing the reaction zone using a mix of a solid catalyst phase (e.g., mixed metal oxide, such as ruthenized titania) and a liquid carrier phase (e.g., organic liquid, such as an alcohol) to form the catalytic coating 109. The mix may comprise a colloid or suspension, e.g., slurry or another mixture, that is formed by wet spraying, brushing on, dip coating, spin coating, etc. on surface 107A of substrate layer 107. Preferably, the organic liquid carrier is selected such that it evaporates before penetrating the entire thickness of the substrate layer. This allows the catalytic coating to achieve the desired penetration depth 107B into the substrate layer 107.

The catalytic coating 109 and the substrate layer 107 portion from surface 107A to depth 107B forms mixed porous sintered metal powder structure having a thin coating 109 of the mixed metal oxide on surface 107A and on the surface of the pores in layer 107. Thus, the coating 109 makes the porosity in the portion of layer 107 between surface 107A and depth 107B slightly smaller than in the rest of the porous sintered metal powder layer 107 beyond depth 107B. Thus, in this embodiment, the flow resistance through the portion of layer 107 between surface 107A and depth 107B is substantially the same (e.g., slightly smaller) than in the rest of the porous sintered metal powder layer 107 beyond depth 107B. In contrast, the flow resistance through layer 108 facing the negative electrode 104 in FIG. 1A is lower than through layer 106 facing away from the negative electrode, while the flow through layer 106 facing the negative electrode 104 in FIG. 1C is higher than through layer 108 facing away from the negative electrode.

The portion of layer 107 coated with the catalytic coating 109 may have a BET surface area that is greater than that of a flat, non-porous titanium layer. For example, it may have a BET surface area that is greater than 1 and less than 20 times, such as between 5 and 10 times that of the flat, non-porous titanium layer. The portion of layer 107 coated with the catalytic coating 109 may have a BET surface area between 0.001 and 0.5 m²/g, such as 0.02 to 0.05 m²/g.

The penetration depth 107B may be between 0.1 and 1 mm, such as 0.25 to 0.5 mm. The thickness of the coating 109 on the surface 107A and on the surface of the pores in the substrate layer 107 may be between 100 and 500 nm, such as 200 to 400 nm. It should be noted that coating 109 may also be applied to the bi-layer structure shown in FIG. 1A, 1B or 1C.

In another alternative embodiment, the multi-porous electrodes 102 are made with multilayer wire meshes (e.g., stacked or joined fine and coarse wire meshes). A wire mesh provides more surface area than a solid plate. Fine or coarse meshes in this embodiment could be, but are not limited to be, manufactured from titanium, tantalum or tungsten wire, or an aluminum wire coated with a thin layer of titanium, tantalum or tungsten deposited by techniques such as electroplating, physical vapor deposition or chemical vapor deposition.

In an alternative embodiment, the multilayer porous electrode contains one or more layers made from a metal foam, as shown in FIG. 2. In this embodiment, one or more of the porous electrode layers, such as the structural backbone layer 106A is made from the metal foam. Examples of metal foams include pure titanium, tantalum, and tungsten metal foams, or carbon or aluminum foams coated with a thin layer of refractory metal, such as titanium, tantalum, or tungsten deposited by techniques such as electroplating, or physical vapor deposition or chemical vapor deposition. The metal foam creates a lower cost stiff and conductive backbone for a thinner layer 108 which may comprise a catalytic metal oxide or which may be coated with a mixed metal oxide catalytic coating 109 described above. Layer 108 may be welded, sintered on or otherwise attached to the foam layer 106, or layer 108 may be sprayed onto layer 106 as described above.

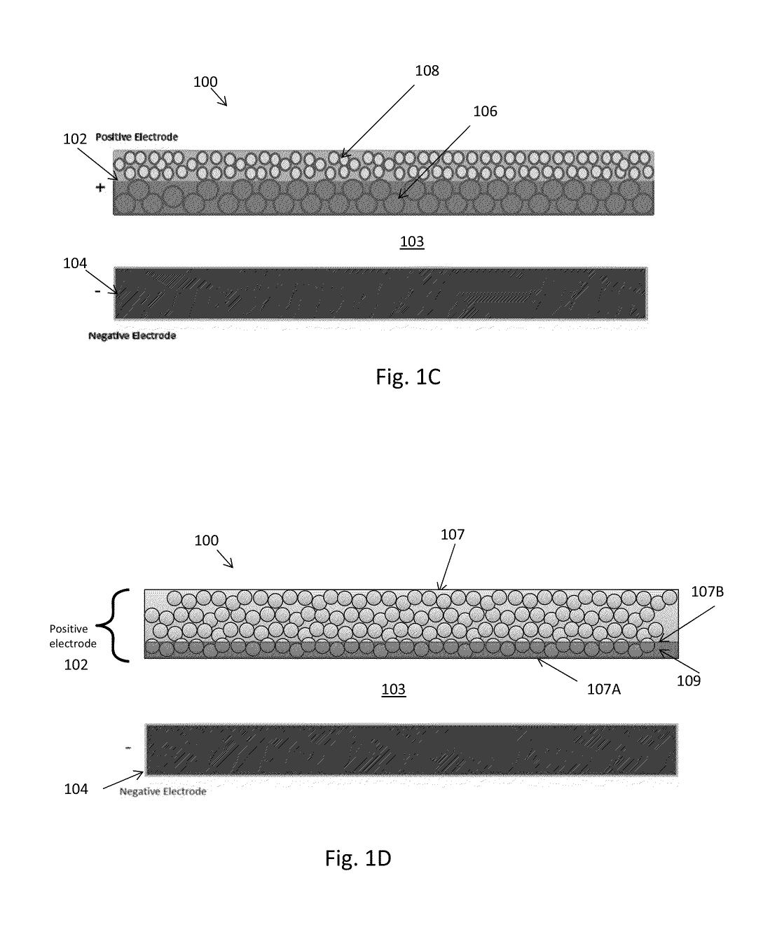

FIGS. 3A-3D illustrate a multi-porous electrode 102 with junction ribs 110 and a sealing rim 112 according to a second embodiment. This design illustrates an economical method of integrating the multi-porous electrode 102 with similarly fabricated junction ribs 110 and/or a sealing rim 112. The performance of the multi-porous electrode 102 is sensitive to the size of mesh used during the sintering process. Using smaller meshes with a tight tolerance on the particle size is more costly than using larger meshes with looser tolerances. In this embodiment, particles larger mesh sizes are used to produce the sealing rim 112 and the junction ribs 110. The ribs 110 connect the positive/porous electrode 102 of one cell with a negative electrode 104 of an adjacent cell in the stack of cells to form an electrode assembly. Electrolyte flow channels are located between adjacent ribs on the side of the positive electrode 102 facing away from the reaction zone 103.

In an embodiment of a method of making the multi-porous electrode 102 illustrated in FIG. 3A, an electrode portion 100 is produced in a “green” pre-sintered state from powder of desired mesh(es) (e.g., the fine and coarse layers described above). Separately, the sealing rim 112 and junction ribs 110 are formed in a green state from a coarse mesh powder. Then, the green sealing rim 112 and junction ribs 110 are provided in contact with the multi-porous electrode 102. The entire green assembly is then sintered. Optionally, the coarsness and final density tolerance of the sealing rim 112 and junction ribs 110 may be selected to meet stiffness and weldability requirements.

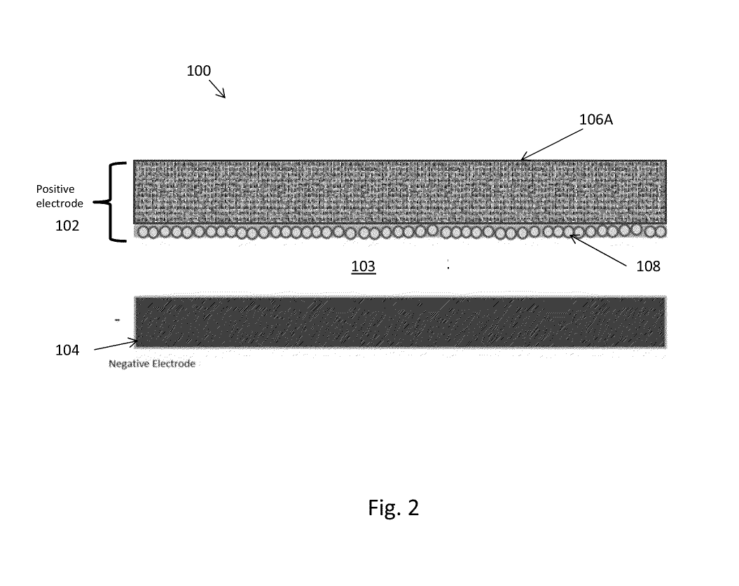

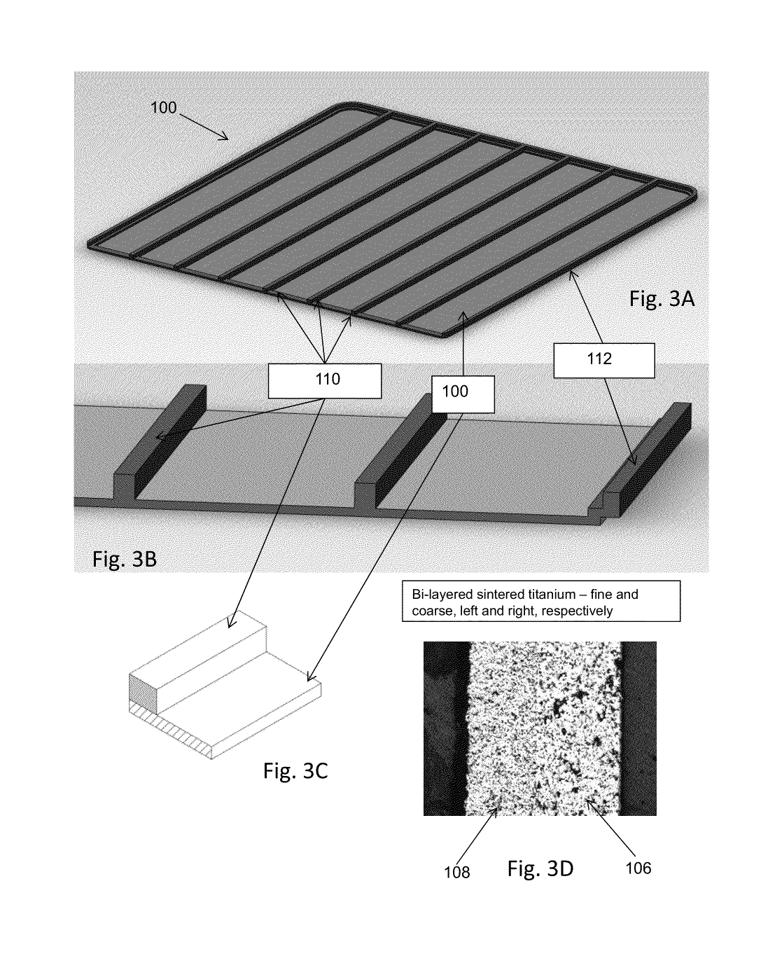

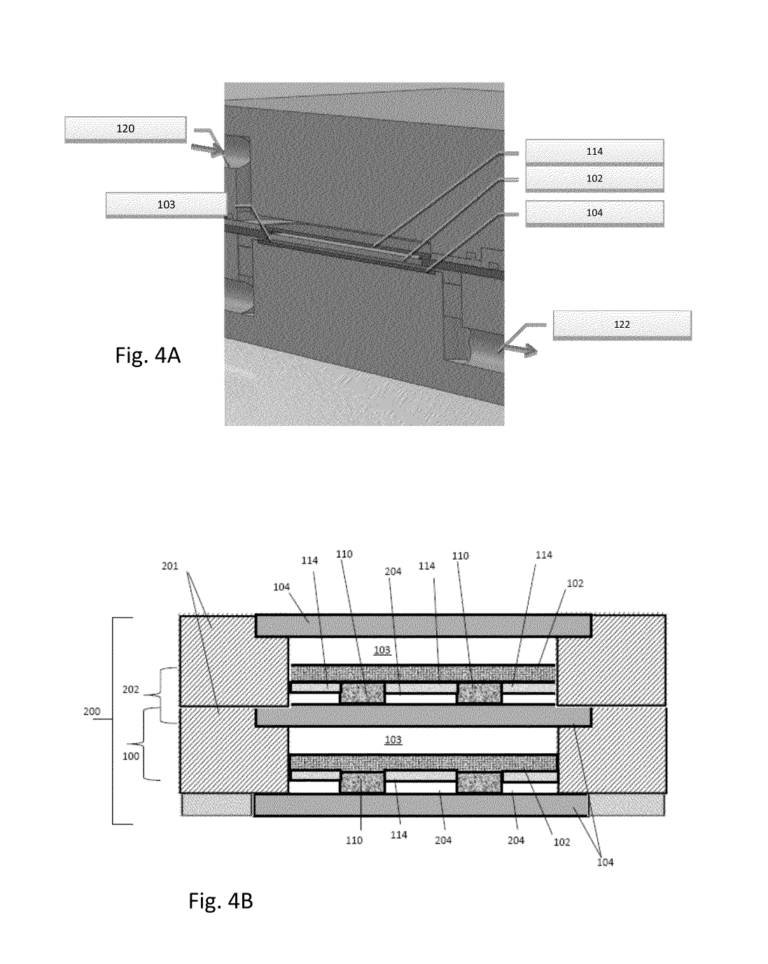

In a third embodiment illustrated in FIGS. 4A and 4B, the electrochemical cell 100 may include a non-conductive porous flow restriction layer 114. The non-conductive porous layer 114 acts as a flow restrictor, improving the uniformity of fluid flow within the porous electrode 102. The cell 100 may be oriented with the porous electrode 102 above the reaction zone 103 as shown in FIG. 4A or with the non-porous electrode 104 located above the reaction zone as shown in FIG. 4B.

FIG. 4B shows a side cross sectional view of a stack 200 of cells 100 supported by a frame 201. Each cell 100 includes the porous 102 and non-porous 104 electrodes separated by a reaction zone 103. A porous electrode 102 of one cell is connected to the non-porous electrode 104 of an adjacent cell by the ribs 110 to form an electrode assembly 202. Electrolyte flow channels 204 are located between the ribs 110 in each electrode assembly 202. Each flow channel 204 is bounded by two ribs (or a rib and a frame 201) on the sides, the flow restriction layer 114 on top (or on the bottom if the stack 200 is flipped upside down as shown in FIG. 4A), and surface of the non-porous electrode 104 facing away from the reaction zone 103 on the bottom (or on top in FIG. 4A configuration). The stack 200 may be located in a flow battery system containing a housing, an electrolyte (e.g., zinc-bromide or zinc-chloride) reservoir and an electrolyte pump.

In an embodiment, the non-conductive porous restriction layer 114 may be affixed to the porous electrode 102 (e.g., the multi-porous electrode of the above embodiments or another porous electrode having a single porosity and/or made by other suitable methods that those described above), as shown in FIG. 4B. Alternatively, the restriction layer 114 may be spaced apart from the porous electrode 102 and be held in place by the frame 200 and/or the ribs 110, as shown in FIG. 4A.

Alternatively, the stack may include an optional alignment part (e.g. molded plastic) that presses the restriction layer 114 against the porous electrode 102. The restriction layer 114 may be co-molded, welded, or otherwise integrated with this alignment part. The restriction layer(s) and corresponding alignment part(s) may be installed during the fabrication of the bipolar electrode assembly 202, such that they are captive, or installed after the bipolar electrode assembly 202 is fabricated such that they are removable.

Layer 114 may comprise layer having slit shaped openings (e.g., cut-outs) such that the ribs 110 protrude through the openings, as shown in FIG. 4B. Alternatively, layer 114 may comprise plural discrete strips which are placed or wedged between the ribs 110 in the flow channels 204. The non-conductive porous restriction layer 114 may be a porous sintered plastic, a plastic felt, a porous ceramic, or a variety of other electrically insulating materials. Advantageously, the non-conductive porous layer 114 may be made of a less expensive material than the porous electrode 102. Optionally, a baffle type structure (electrically insulating baffles located between spaced apart layer 114 and electrode 102) may also be used to improve the fluid flow distribution.

FIG. 4C illustrates an exemplary embodiment of a flow battery cell with the porous restriction layer. The cell shown in FIG. 4C is similar to the cell shown in FIG. 1A, except that the cell in FIG. 4C contains an additional porous restriction layer 114 on the opposite side of layer 106 from layer 108.

As described above, the layer 108 facing the negative electrode 104 and the reaction zone 103 is designed to maximize catalytic activity by achieving a high surface area and a structure that facilitates the uniform application of the catalytic coating 109. An example construction for this layer 108 is a relatively tightly controlled distribution of titanium particle sizes sintered together. Layer 108 may have a BET surface area that is greater than that of a flat, non-porous titanium layer. For example, layer 108 may have a BET surface area that is greater than 1 and less than 20 times, such as between 5 and 10 times that of the flat, non-porous titanium layer. Layer 108 may have a BET surface area between 0.001 and 0.5 m²/g, such as between 0.02 to 0.05 m²/g.

Since the coating and substrate material in this layer 108 may be fairly expensive, the layer 108 (i.e., layer 108 comprised of sintered metal oxide catalyst particles, or layer 108 comprised of sintered metal or metal oxide particles coated with a thin mixed metal oxide catalytic coating 109) is only as thick as necessary to provide sufficient catalytic activity. As a result, this layer 108 may not be thick enough to provide sufficient conductivity or stiffness.

The next layer 106 takes care of this issue by providing a lower cost electrically conductive and structural backbone. An example construction for this layer 106 is a loosely distributed range of titanium particle sizes sintered together and subsequently sintered or welded to the layer 108. The conductive material in this layer 106 may still be relatively expensive, so it is only thick enough to achieve the required conductivity and stiffness. Layer 106 may be thicker than layer 108. For example, the total thickness of layers 106 and 108 (i.e., of electrode 102) should be sufficient to provide an area specific resistance that is equal to that of a 0.25 mm to 1 mm thick, non-porous titanium plate, to provide a sufficient conductivity for the positive electrode 102. For example, the in-plane resistance of a planar electrode sheet 102 (e.g., combination of layers 106 and 108 or layers 107 and 109) per centimeter width and centimeter depth is between 2×10⁻⁴ and 5×10⁻¹ ohms, such as 2×10⁻³ and 5×10⁻².

However, this thickness of layers 106 and 108 may not be thick enough, given their permeability characteristics, to provide the desired flow resistance for the flow of the electrolyte. The non-conductive porous restriction layer 114 provides an even lower cost flow control layer. Since this layer does not need to be conductive, it can be made from a much lower cost material, such as a plastic. An example construction for this layer 114 is a relatively tightly controlled range of HDPE particle sizes sintered together. Layer 114 may be thicker than layers 106 and 108 to provide sufficient flow resistance (i.e., a desired permeability). For example, the gas permeability of the porous restriction layer 114 may be between 1×10⁻¹⁰ and 5×10 cm², such as between 1×10⁻⁸ and 5×10⁻⁷ cm².

FIG. 4D illustrates another exemplary embodiment of a flow battery cell with the porous restriction layer. The cell shown in FIG. 4D is similar to the cell shown in FIG. 1D, except that the cell in FIG. 4D contains an additional porous restriction layer 114 on the opposite side of the substrate layer 107 from the surface 107A coated with the catalytic coating 109. Since the permeability and thickness of the positive electrode 102 (composed of layer 107 and coating 109) may not yield the desired flow resistance, the low cost flow control layer 114 is mated against the opposite surface of the porous electrode 102 from surface 107A. Since this layer 114 does not need to be conductive, it can be made from a much lower cost material, such as a plastic. An example construction for this layer 114 is a relatively tightly controlled range of HDPE particle sizes sintered together.

The positive electrode 102 (i.e., layers 107/109 or layers 106/108) preferably has a sufficient stiffness to be suspended across the reaction zone. Preferably, the flexural modulus times thickness cubed parameter of the positive electrode is between 0.1 and 1200 Newton-meters, such as between 10 and 100 Nm. This parameter correlates to the bending stiffness per cm width and cm length of the electrode 102. If the electrode is connected to the porous restriction layer 114, then the flexural modulus times thickness cubed parameter of combination of the positive electrode 102 and layer 114 is between 0.1 and 1200 Newton-meters, such as between 10 and 100 Nm.

The values of the gas permeability, in-plane resistance, and bending stiffness are a function of the porous electrode geometry. For example, the porous restriction layer 114 (i.e., a flow control layer) increases a fluidic resistance of the electrolyte flowing through the porous positive electrode 102 and thereby distributes the flow more uniformly. For a shorter electrode 102, the desired flow uniformity can be achieved with a smaller fluidic resistance in the flow control layer (i.e. thinner and/or more permeable layer) because the flow resistance along the reaction zone is a smaller fraction of the total.

For layers 106, 106A or 107 (i.e., the conductivity enhancing layer), the lateral distance that current must flow through the electrode 102 before it can flow into an adjacent cell (e.g., through a junction rib 110 shown in FIGS. 3A and 3B) has a significant impact on the resistivity/thickness characteristic of these layers 106, 106A or 107. In other words, the number of junction ribs 110 varies inversely with thickness and conductance of layers 106, 106A or 107 (i.e., more ribs allows the use of a thinner layer or a more resistive layer).

Similarly, the bending stiffness depends on the length of the unsupported span of the electrode 102 (or the combination of the electrode 102 and layer 114). If the porous electrode is supported in the reaction zone 103 by one or more plastic spacer ribs 211 shown in FIG. 4E, then the electrode thickness and modulus may be decreased. In other words, the electrode 102 thickness and flexural modulus are inversely proportional to the area between the spacer ribs.

FIG. 4E illustrates a top view of the cell frame 201 for holding the horizontally positioned flow battery cells, which are illustrated is side cross sectional view in FIG. 4B. The cell frame 201 is described in more detail in U.S. patent application Ser. No. 13/630,572, filed on Sep. 28, 2012 and incorporated herein by reference in its entirety. The frame 201 includes an inlet manifold 205 and the outlet manifolds 207, 209. The manifolds are respective openings through the frame 201 which align with similar openings in other stacked frames 201 to form the manifolds.

The plastic cell frame 201 contains a plurality of plastic spacer ribs 211 which support the porous electrode 102 over the reaction zone 103. The active area 213 (e.g., opening in middle of frame 201 containing the electrodes 102, 104) is separated into flow areas 215.

The flow areas 215 may be between 200 mm and 1000 mm long (i.e., in the direction between manifolds 205 and 207/209), such as 300 to 500 mm long, and between 50 to 150 mm wide (i.e., in the direction perpendicular to the length direction), such as 75 to 100 mm wide. The above described values of gas permeability, in-plane resistance, and bending stiffness are suitable for the flow area 215 dimensions described above. In other words, for the flow areas 215 described above, the gas permeability of the porous restriction layer 114 may be between 1×10⁻¹⁰ and 5×10 cm², such as between 1×10⁻⁸ and 5×10⁻⁷ cm², the in-plane resistance of a planar electrode sheet 102 per centimeter width and centimeter depth may be between 2×10⁻⁴ and 5×10⁻¹ ohms, such as between 2×10⁻³ and 5×10⁻² and the flexural modulus times thickness cubed parameter of combination of the positive electrode 102 (or the combination of electrode 102 and layer 114) may be between 0.1 and 1200 Newton-meters, such as between 10 and 100 Nm. Other values may be used for different flow area dimensions.

As shown in FIG. 4A, electrolyte enters the electrochemical cell 100 via the inlet 120 between adjacent cells in the flow battery stack and spreads through flow channels 204 (shown in FIG. 4B) across the non-conductive porous layer 114 before passing to the porous electrode 102, thereby evening the flow to the porous electrode 102 below. After passing through the porous electrode 102, the electrolyte flows through the reaction zone 103 and exits the electrochemical cell 100 via an outlet 122.

Alternatively, as shown in FIG. 4F, the electrolyte enters the cell 100 through the reaction zone 103, and then at least a portion of the electrolyte flows through the porous electrode 102 and out of the cell through the flow channels 204. The electrolyte inlet flow is provided by pump 123 from reservoir 119 via inlet conduit 115 into the inlet manifold 205 and then into the reaction zone 103. The electrolyte then flows through the reaction zone 103 and through the porous electrodes 102 into the flow channels 204 and out through respective manifolds 209, 207 and respective return conduits 120A and 120B back into the reservoir 119. The respective return conduits 120A and 120B may be configured with calibrated pipe restrictions 602a, 602b and on/off valves 604a, 604b, in order to control the flow ratios of the exit flow streams. Valve 604a is closed and valve 604b is open in charge mode. In contrast, valve 604a is open and valve 604b is closed in discharge mode.

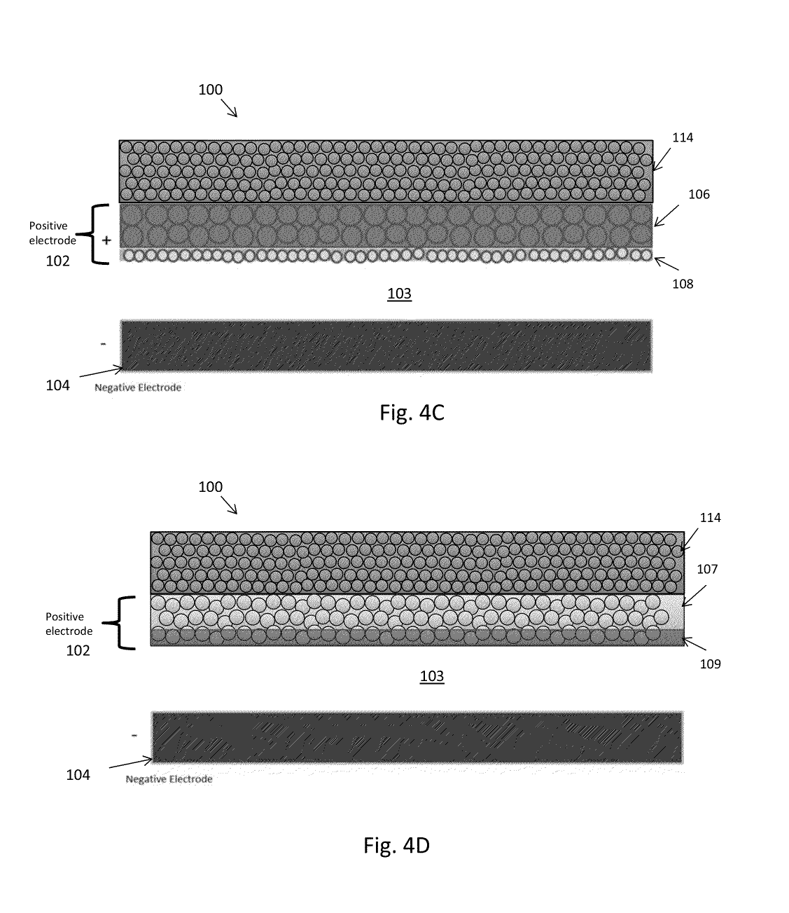

Using computational fluid dynamics (CFD), the potential impact of a separate porous restriction layer 114, the effect of any gap between the restriction layer 114 and the porous electrode 102 and the effect of an additional baffle structure in the gap were analyzed. FIG. 5 shows several configurations were modeled in a 2-D CFD study. Configurations modeled include: (1) no non-conductive porous layer 114, (2) a non-conductive porous layer 114 located immediately adjacent the porous electrode 102 (no gap), (3) a non-conductive porous layer 114 located with a 1 mm gap between the non-conductive porous layer 114 and the porous electrode 102, (4) a non-conductive porous layer 114 located with a 1 mm gap between the non-conductive porous layer 114 and the porous electrode 102 and a baffle structure of 1 mm wide junction ribs 110 (or additional insulating baffles) separated 9 mm apart, (5) a non-conductive porous layer 114 located with a 1 mm gap between the non-conductive porous layer 114 and the porous electrode 102 and a baffle structure of 0.5 mm wide junction ribs 110 (or additional insulating baffles) separated 4.5 mm apart and (6) a non-conductive porous layer 114 located with a 1 mm gap between the non-conductive porous layer 114 and the porous electrode 102 and a baffle structure of junction ribs 110 (or additional insulating baffles) with varying separation distance (e.g., decreasing in electrolyte flow direction) between adjacent junction ribs.

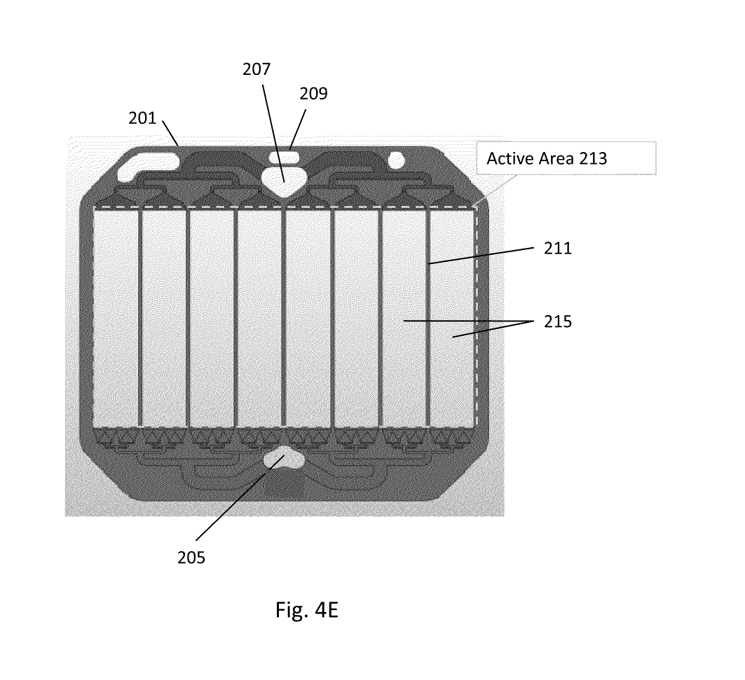

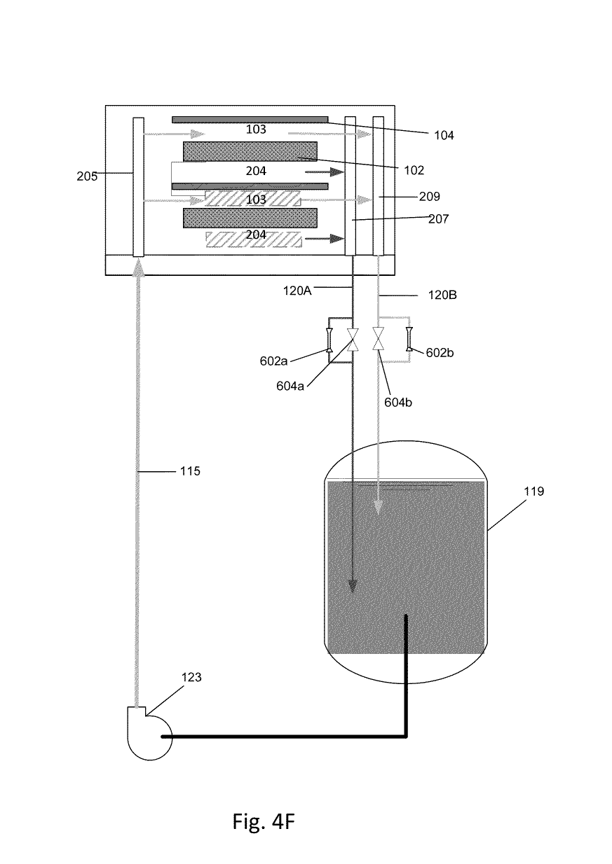

The results of the CFD simulations are illustrated in FIGS. 6 and 7. FIG. 6 compares the electrolyte velocity in the porous electrode 102 with and without an additional non-conductive porous restriction layer 114 (with and without a gap between electrode 102 and layer 114). FIG. 7 compares the electrolyte velocity in the device having the restriction layer 114 separated from the porous electrode 102 with baffle structures (e.g., junction ribs 110) to the configuration with no gap between layer 114 and electrode 102). The results of the CFD studies suggest that the “no gap” configuration (the porous restriction layer bonded to the porous electrode) appear effective at evening the fluid flow, as shown in FIG. 6. A configuration including a gap between the non-conductive porous restriction layer 114 and the porous electrode 102 showed an improvement in electrolyte velocity distribution at the inlet 120, but showed little impact at the outlet 122. Each of the “baffle” configurations in FIG. 7 provided a similar improvement as the configuration in which layer 114 contacts the electrode 104.

Another embodiment is drawn to an electrode assembly which includes a porous electrode 102 affixed to an impermeable electrode 102. The electrodes may be affixed by any suitable method, such as welding or brazing. Example electrode assemblies are described in U.S. patent application Ser. No. 12/877,884, filed Sep. 8, 2010, hereby incorporated in its entirety.

### Test Results

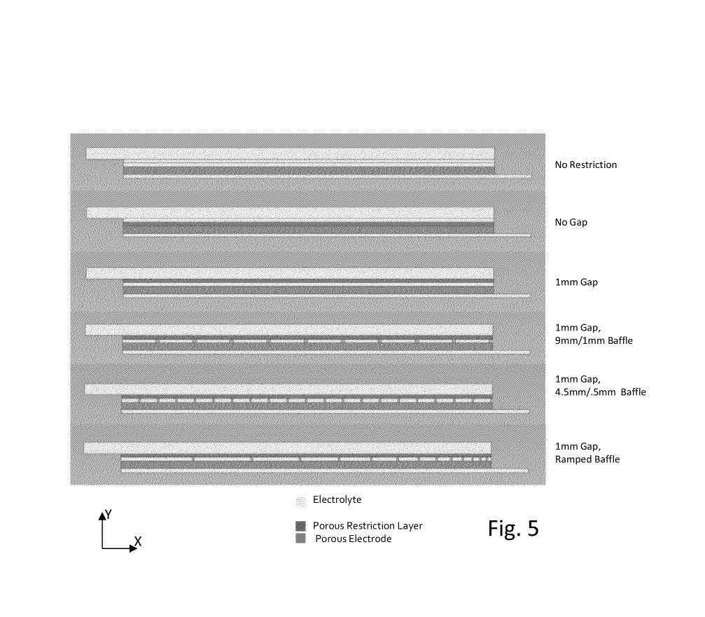

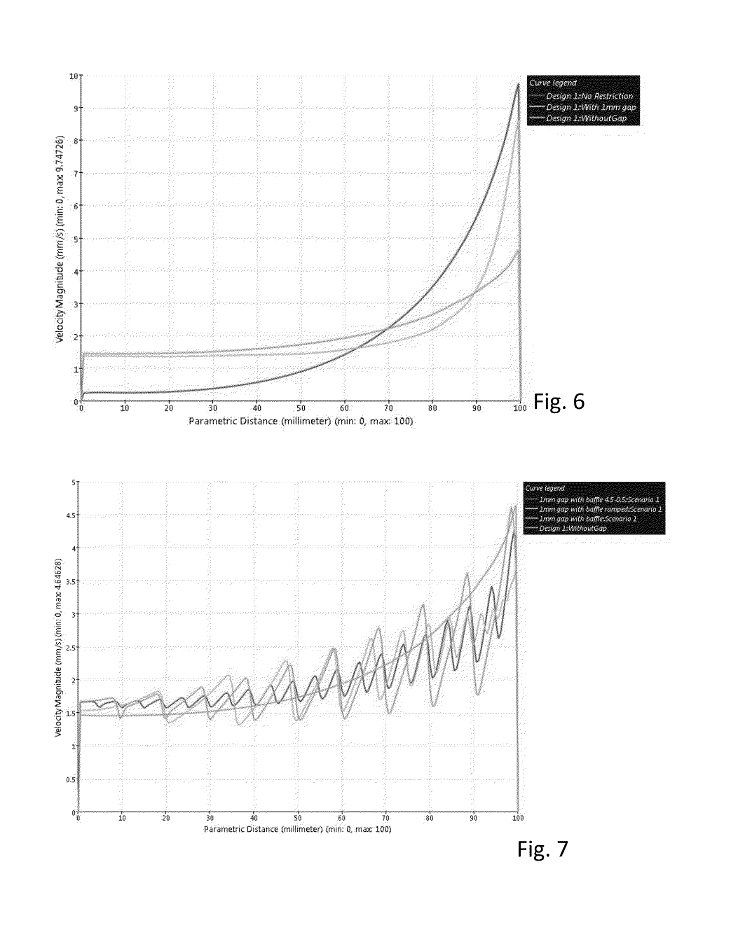

The average pore size and surface area data for five porous electrodes 102 made of various powder sizes and assemblies are presented for comparison: (1) mono-layer made from mesh-100 powder, (2) mono-layer made from mesh-100 and -325 mixed powders, (3) bilayer made from mesh-100 and mesh-325 powders, (4) bilayer made from coarse layer made from mesh-100 powder and sprayed on mesh-325 fine layer and (5) monolayer made from mesh-325. The pore size and surface area were measured by the capillary flow porosimetry technique. FIG. 8 illustrates the average pore sizes of these electrodes. As can be seen in FIG. 8, the average pore size of the multi-layer electrodes (3), (4) is as small as the monolayer (5) of fine mesh particles. FIG. 9 illustrates the average surface area of the electrodes. The average surface area of multilayer electrodes (3), (4) is higher than any of the monolayer electrodes (1), (2), (5).

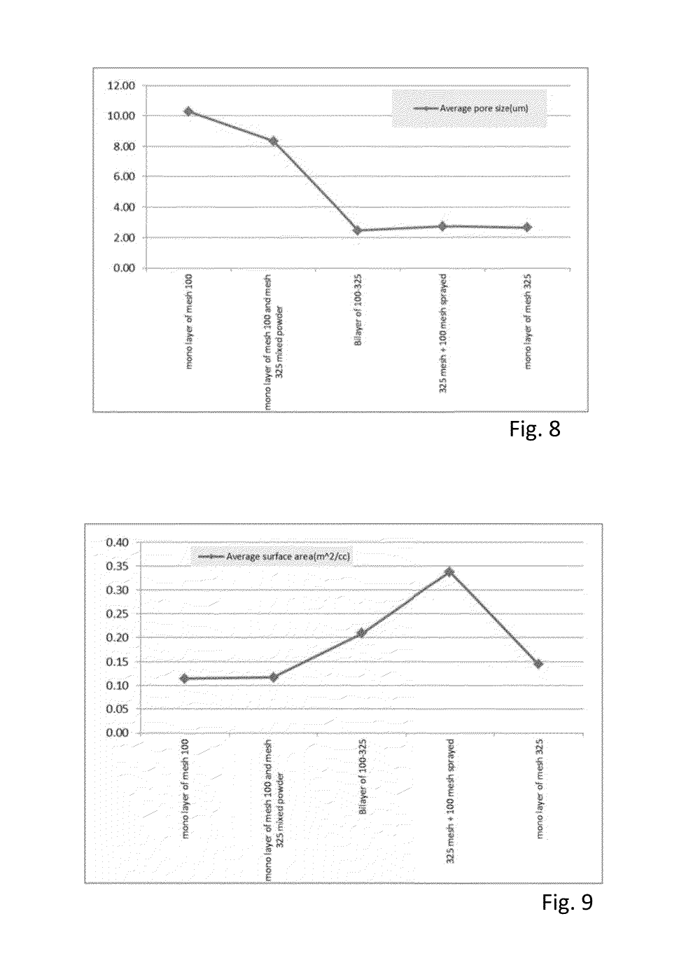

FIGS. 10A and 10B are micrographs illustrating the microstructure of a comparative monolayer electrode and a bilayer multi-porous electrode, respectively. FIG. 10A illustrates the microstructure of a single layer porous electrode made from a mesh-325, while FIG. 10B illustrates the microstructure of a bilayer multi-porous electrode made from a mesh-325 layer and a mesh-100 powder. In FIG. 10B, the coarse mesh-100 microstructure is on the right side and the fine mesh-325 microstructure is on the left side.

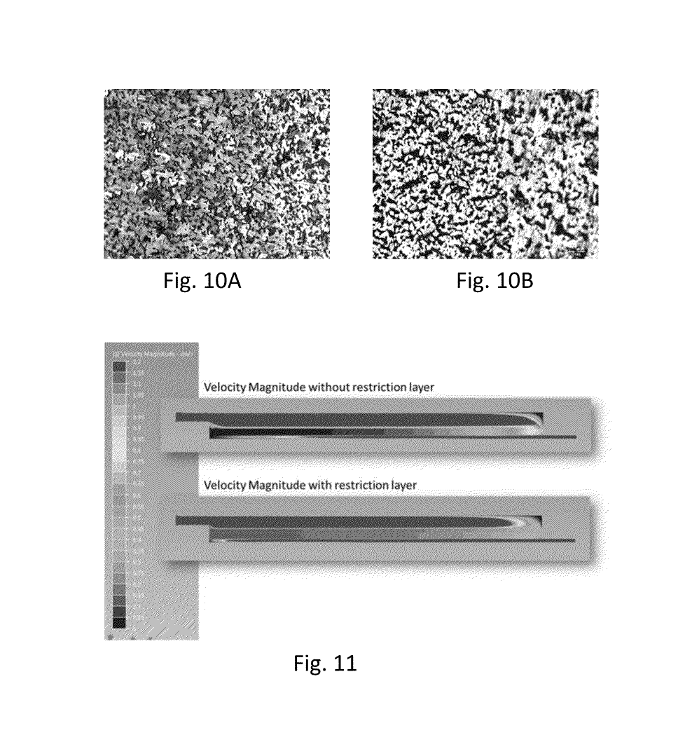

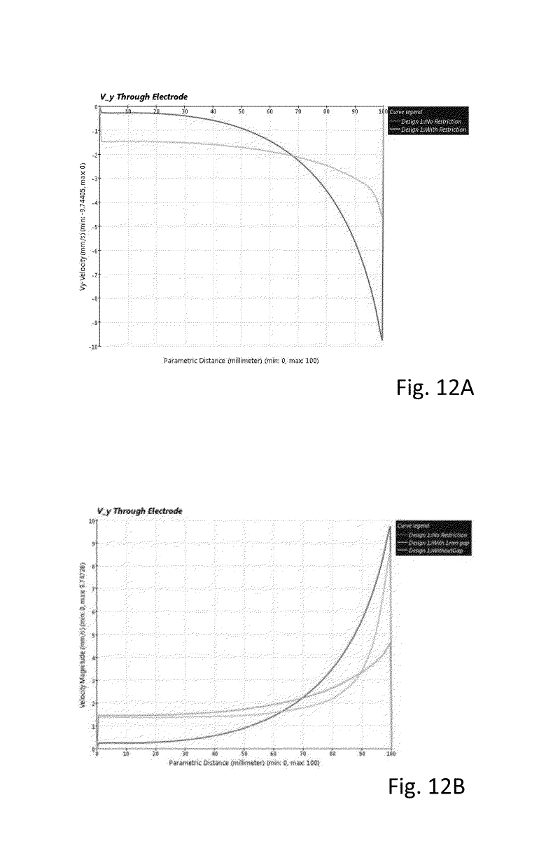

FIG. 11 is a simulation illustrating the fluid velocity through a porous electrode with and without a porous restriction layer 114 of the third embodiment. As can be seen in the lower simulation, the restriction layer provides much uniform flow velocity. FIG. 12A is a plot of the velocity through the electrode as a function of normalized distance (0-100%) along the electrode. FIG. 12A clearly shows that the addition of a porous restriction layer provides a more uniform flow velocity. FIG. 12B illustrates effect of using a porous restriction layer in combination with a gap on the flow velocity distribution. As can been seen in FIG. 12B, the addition of the gap decreases the uniformity of the velocity distribution relative to the use of a restriction layer without a gap. However, the use of a restriction layer and a gap provides a more uniform velocity distribution than not using a restriction layer.

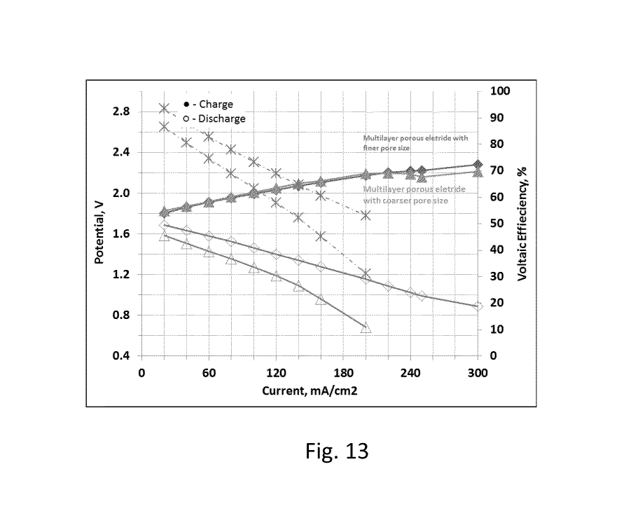

FIG. 13 below presents the electrochemical polarization curves at different charge and discharge current densities obtained with the porous electrodes made from different mesh sizes material. As can be seen FIG. 13, the electrode with the finer size shows lower overpotential for charge and much lower overpotentials for discharge current. The finer mesh size porous electrode has a much higher surface area. Thus, the finer mesh size porous electrode has a significantly higher electrochemical activity and superior voltaic efficiency for a given current density.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A porous electrode for a flow battery comprising a first layer and a second layer, wherein the first layer has at least one of a different catalytic property or a different permeability than the second layer.

2. The electrode of claim 1, wherein the first layer has a lower catalytic property than the second layer.

3. The electrode of claim 2, wherein the second layer comprises at least one of sintered metal oxide powder which catalyzes oxidation of a metal-halide electrolyte to form halogen ions, or a sintered metal or metal oxide powder which is coated with a mixed metal oxide catalytic coating which catalyzes oxidation of the metal-halide electrolyte to form the halogen ions.

4. The electrode of claim 3, wherein the first layer comprises at least one of a porous metal foam, a porous metal oxide foam, or a porous sintered metal or metal oxide powder, and wherein the first layer is thicker than the second layer.

5. The electrode of claim 4, wherein the first layer comprises a sintered first powder having a first size distribution and the second layer comprises a sintered second powder having a second size distribution which is tighter than the first size distribution.

6. The electrode of claim 5, wherein:
the first powder comprises titanium metal, tungsten metal, tantalum metal, titanium oxide, tantalum oxide, tungsten oxide or combinations thereof; and
the second powder comprises titanium metal, tungsten metal, tantalum metal, titanium oxide, tantalum oxide, tungsten oxide, or combinations thereof coated with the catalytic coating of ruthenium oxide and titanium oxide.

7. The electrode of claim 6, wherein the second layer is coated on the first layer.

8. The electrode of claim 2, wherein the second layer has a BET surface between 0.001 and 0.5 m²/g.

9. The electrode of claim 2, wherein the first layer comprises a sintered metal or metal oxide powder substrate layer and the second layer comprises a mixed metal oxide catalytic coating which is coated onto a portion of the substrate layer.

10. The electrode of claim 9, wherein first layer comprises a sintered titanium powder substrate layer and the second layer comprises a 100 to 500 nm thick mixed ruthenium oxide and titanium oxide coating which extends into the first substrate layer to a penetration depth between 0.1 and 1 mm.

11. A metal halogen flow cell comprising a positive electrode comprising the electrode of claim 1 and a negative electrode separated from the positive electrode by a separator free reaction zone, wherein the second layer faces the negative electrode and the reaction zone of the flow cell.

12. The metal halogen flow cell of claim 11, further comprising an electrically insulating porous restriction layer located between the positive electrode and negative electrode of an adjacent flow cell.

13. The metal halogen flow cell of claim 12, wherein the restriction layer comprises a porous plastic layer which is located in contact with the second layer of the positive electrode.

14. The metal halogen flow cell of claim 13, wherein:
the positive electrode and the negative electrode are supported by a stack of insulating cell frames;
the positive electrode is supported in the reaction zone by one or more insulating spacer ribs;
the one or more spacer ribs divide an active area opening in each cell frame into a plurality of flow areas;
each of the plurality of the flow areas is between 200 mm and 1000 mm long and between 50 to 150 mm wide;
a gas permeability of the porous restriction layer is between 1×10⁻¹⁰ and 5×10⁻⁶ cm²;
an in-plane resistance of the positive electrode per centimeter width and centimeter depth is between 2×10⁻⁴ and 5×10⁻¹ ohms; and
a flexural modulus times thickness cubed parameter of a combination of the positive electrode and the porous restriction layer is between 0.1 and 1200 Newton-meters.

15. An electrochemical flow battery comprising a plurality of flow cells of claim 11, an electrolyte reservoir and an electrolyte pump.

16. The electrode of claim 2, wherein the first layer has a higher permeability, a lower permeability or substantially the same permeability as the second layer.

17. The electrode of claim 1, wherein the first layer has a higher permeability or a lower permeability than the second layer.

18. A method of making a porous electrode for a flow battery, comprising:
providing a first substrate layer comprising a sintered metal or metal oxide powder substrate layer; and
coating a portion of the first substrate layer with a mixed metal oxide catalytic coating.

19. The method of claim 18, wherein first substrate layer comprises a sintered titanium powder substrate layer and the second layer comprises a 100 to 500 nm thick mixed ruthenium oxide and titanium oxide coating which extends into the first substrate layer to a penetration depth between 0.1 and 1 mm.

20. The method of claim 19, wherein the step of coating comprises coating a mix of a solid catalyst phase and a liquid carrier phase on the first substrate layer.

21. The method of claim 20, wherein the mix comprises a colloid or suspension of solid ruthenium oxide and titanium oxide in an organic liquid which evaporates before penetrating an entire thickness of the first substrate layer after the step of coating to achieve the mixed ruthenium oxide and titanium oxide coating penetration depth of between 0.1 and 1 mm into the first substrate layer.

22. A method of making an electrochemical flow cell, comprising:
providing a positive electrode made by the method of claim 18;
providing a negative electrode spaced apart from the positive electrode by a reaction zone, such that the positive electrode so that the second layer faces the negative electrode and the reaction zone.

23. The method of claim 21, further comprising providing an insulating porous restriction layer located between the positive electrode and a negative electrode of an adjacent flow cell.
